(19) United States
(12) Patent Application Publication
(10) Pub. No.: US 2015/0034318 A1
(43) Pub. Date: Feb. 5, 2015

(54) AQUEOUS SOLUTION AND METHOD FOR USE THEREOF

(71) Applicant: Schlumberger Technology Corporation, Sugar Land, TX (US)

(72) Inventors: Li Jiang, Katy, TX (US); Timothy G.J. Jones, Cambridge (GB); Rick Hutchins, Sugar Land, TX (US); Bruno Lecerf, Houston, TX (US); Murtaza Ziauddin, Katy, TX (US); Jian He, Sugar Land, TX (US)

(73) Assignee: Schlumberger Technology Corporation, Sugar Land, TX (US)

(21) Appl. No.: 13/955,468

(22) Filed: Jul. 31, 2013

(51) Int. Cl. C09K 8/00; E21B 43/25

(52) U.S. Cl. CPC C09K 8/00; E21B 43/25
USPC 166/300; 507/244

(57) ABSTRACT

A method of treating a formation includes preparing an aqueous solution having HCl in an amount between greater than 15% and 45.7% by weight, inclusive. The prepared aqueous solution includes a fixing agent (FA) present in a molar ratio of FA:HCl between 0.15 and 2.5 inclusive, where the FA is urea and/or a urea derivative, and further includes water present in an amount sufficient to dissolve the HCl and the FA. The aqueous solution includes substantially no polysaccharides.

The method further includes providing an oilfield treatment fluid including the aqueous solution to a high pressure pump operating the high pressure pump to treat a wellbore and/or the formation fluidly coupled to the wellbore.

### RELATED APPLICATION DATA

None.

### BACKGROUND

The statements in this section merely provide background information related to the present disclosure and may not constitute prior art.

The technical field generally, but not exclusively, relates to high concentration of hydrochloric acid (HCl) solutions with urea, and uses thereof. Previously known solutions of HCl with urea, for example as described in U.S. Pat. No. 4,466,893, utilize urea with low concentrations of HCl (at or below 15%) and in the presence of various plant-based polysaccharide gums. HCl above 15% was determined to be deleterious to the properties of previously available solutions.

### SUMMARY

Embodiments pertain to aqueous solutions having a concentration of HCl exceeding 15% by weight, further including urea and/or a urea derivative, and being substantially free of polysaccharides. Other embodiments include methods to prepare acid-urea solutions and treat oilfield formations. This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 depicts example equipment to treat a wellbore and/or a formation fluidly coupled to the wellbore.

FIG. 2 depicts illustrative data showing comparative PVBT data between an HCl solution with and without a Fixing Agent.

### DETAILED DESCRIPTION OF SOME ILLUSTRATIVE EMBODIMENTS

For the purposes of promoting an understanding of the principles of the disclosure, reference will now be made to the embodiments illustrated in the drawings and specific language will be used to describe the same. It will nevertheless be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the compositions used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that the Applicant appreciates and understands that any and all data points within the range are to be considered to have been specified, and that the Applicant possessed knowledge of the entire range and all points within the range.

The term “substantially no polysaccharides” as utilized herein should be understood broadly. An example solution having substantially no polysaccharides includes a solution without any polysaccharides intentionally present in the solution. Another example solution having substantially no polysaccharides includes a fluid having polysaccharides only incidentally, for example as part of an additive, and not in an amount sufficient to support development of higher viscosity in the fluid. Example amounts of polysaccharides present in a solution include less than 2 pounds polysaccharide per thousand gallons, less than 1 pound polysaccharide per thousand gallons, less than 0.5 pounds polysaccharide per thousand gallons, less than 0.1 pounds polysaccharide per thousand gallons, and a solution having no polysaccharides. Yet another example solution having substantially no polysaccharides includes a fluid having no detectable polysaccharides, where the detection is performed through rheological testing. Yet another example solution having substantially no polysaccharides contemplates that polysaccharides include materials such as: galactomannans such as guar gum, gum karaya, gum tragacanth, gum ghatti, gum acacia, gum konjak, shariz, locus, psyllium, tamarind, gum tara, carrageenan, gum kauri, and modified guars such as hydroxy-propyl guar, hydroxy-ethyl guar, carboxy-methyl hydroxy-ethyl guar, and carboxy-methyl hydroxy-propyl guar.

The term formation as utilized herein should be understood broadly. A formation includes any underground fluidly porous formation, and can include without limitation any oil, gas, condensate, mixed hydrocarbons, paraffin, kerogen, water, and/or CO₂ accepting or providing formations. A formation can be fluidly coupled to a wellbore, which may be an injector well, a producer well, and/or a fluid storage well. The wellbore may penetrate the formation vertically, horizontally, in a deviated orientation, or combinations of these. The formation may include any geology, including at least a sandstone, limestone, dolomite, shale, tar sand, and/or unconsolidated formation. The wellbore may be an individual wellbore and/or a part of a set of wellbores directionally deviated from a number of close proximity surface wellbores (e.g. off a pad or rig) or single initiating wellbore that divides into multiple wellbores below the surface.

The term “oilfield treatment fluid” as utilized herein should be understood broadly. In certain embodiments, an oilfield treatment fluid includes any fluid having utility in an oilfield type application, including a gas, oil, geothermal, or injector well. In certain embodiments, an oilfield treatment fluid includes any fluid having utility in any formation or wellbore described herein. In certain embodiments, an oilfield treatment fluid includes a matrix acidizing fluid, a wellbore cleanup fluid, a pickling fluid, a near wellbore damage cleanup fluid, a surfactant treatment fluid, an unviscosified fracture fluid (e.g. slick water fracture fluid), and/or any other fluid consistent with the fluids otherwise described herein. An oilfield treatment fluid may include any type of additive known in the art, which are not listed herein for purposes of clarity of the present description, but which may include at least friction reducers, inhibitors, surfactants and/or wetting agents, fluid diverting agents, particulates, acid retarders (except where otherwise provided herein), organic acids, chelating agents, energizing agents (e.g. CO₂ or N₂), gas generating agents, solvents, emulsifying agents, flowback control agents, resins, breakers, and/or non-polysaccharide based viscosifying agents.

The term “high pressure pump” as utilized herein should be understood broadly. In certain embodiments, a high pressure pump includes a positive displacement pump that provides an oilfield relevant pumping rate—for example at least 0.5 barrels per minute (bpm), although the specific example is not limiting. A high pressure pump includes a pump capable of pumping fluids at an oilfield relevant pressure, including at least 500 psi, at least 1,000 psi, at least 2,000 psi, at least 5,000 psi, at least 10,000 psi, up to 15,000 psi, and/or at even greater pressures. Pumps suitable for oilfield cementing, matrix acidizing, and/or hydraulic fracturing treatments are available as high pressure pumps, although other pumps may be utilized.

The term “treatment concentration” as utilized herein should be understood broadly. A treatment concentration in the context of an HCl concentration is a final concentration of the fluid before the fluid is positioned in the wellbore and/or the formation for the treatment. The treatment concentration may be the mix concentration available from the HCl containing fluid at the wellsite or other location where the fluid is provided from. The treatment concentration may be modified by dilution before the treating and/or during the treating. Additionally, the treatment concentration may be modified by the provision of additives to the fluid. Example and non-limiting treatment concentrations include 7.5%, 15%, 20%, 28%, 36%, and/or up to 45.7% HCl concentration in the fluid. In certain embodiments, a treatment concentration is determined upstream of additives deliver (e.g. at a blender, hopper, or mixing tub) and the concentration change from the addition of the additives is ignored. In certain embodiments, the treatment concentration is a liquid phase or acid phase concentration of a portion of the final fluid—for example when the fluid is an energized or emulsified fluid. In certain embodiments the treatment concentration exceeds 15%. In certain embodiments, the fluid concentration exceeds 36% or exceeds 37%.

The term “high surface area particles” as utilized herein should be understood broadly. In certain embodiments, a high surface area particle is a particle having a complex or porous surface which provides a greater surface area than a simple geometrical particle. An example high surface particle is a porous particle, a metal organic framework, a particle having greater than 100 m²/g, greater than 500 m²/g, greater than 1000 m²/g, and/or greater than 10,000 m²/g. Zeolites, clays, and/or materials suited for catalytic reactions can also be formulated to be high surface area particles.

The term “urea derivative” as used herein should be understood broadly. An example urea derivative includes any urea compound having at least one of the four nitrogen bonded hydrogens substituted. The substitution products may be anything, but include at least any hydrocarbon group, and may include substitutions on one or both of the urea nitrogens. Additionally or alternatively, substitutions may include cyclic groups (e.g. ethylene urea), aromatic groups, and/or nitrogen containing hydrocarbon groups. The inclusion of a urea derivative in the present disclosure should not be read as limiting to other urea derivatives which may be used as an alternative or addition.

An example aqueous solution includes HCl present in an amount that is greater than 15% and up to 45.7%, inclusive. The aqueous solution further includes a fixing agent (FA) which is urea and/or a urea derivative. The solution further includes water at least in an amount sufficient to dissolve the HCl and the FA. The FA is present in a molar ratio between the FA and HCl, where the molar ratio FA:HCl is at least 0.15 up to 2.5. The example aqueous solution includes substantially no polysaccharides.

In certain further embodiments, the molar ratio of FA:HCl is between 1.0 and 2.0 inclusive, between 0.5 and 2.0 inclusive, between 0.5 and 1.25 inclusive, between 0.3 and 1.25 inclusive, between 1.0 and 1.7 inclusive, and/or about 1.7. Additionally or alternatively, all of the molar ratios FA:HCl resulting from the preparation of any fluids from Table 1 following are contemplated herein. The fluids depicted in Table 1 are non-limiting examples, and in certain embodiments include fluids prepared before dilution into an oilfield treatment fluid.

In certain embodiments, each molecular species of the FA includes a molecule having a molecular weight below 100 g/mol, and/or the solution includes the FA:HCl having a ratio between 0.3 and 1.65 inclusive. In certain embodiments, each molecular species of the FA includes a molecule having a molecular weight below 120 g/mol, and/or the solution includes the FA:HCl having a ratio between 0.27 and 1.25 inclusive. In certain embodiments, each molecular species of the FA includes a molecule having a molecular weight below 150 g/mol, and/or the solution includes the FA:HCl having a ratio between 0.22 and 1.05 inclusive. In certain embodiments, each molecular species of the FA includes a molecule having a molecular weight below 175 g/mol, and/or the solution includes the FA:HCl having a ratio between 0.18 and 1.0 inclusive. In certain embodiments, the FA includes urea and the solution includes the FA:HCl having a ratio between 0.5 and 2.25 inclusive.

The selection of a molar ratio of FA:HCl depends upon the specific embodiment, and is a mechanical step for one of skill in the art having the benefit of the disclosures herein. It will be understood that an upper limit of FA is present as the solubility of the FA and HCl in the aqueous solution is reached, and that higher molecular weight FA materials will provide lower molar ratios of FA:HCl at the highest HCl concentrations. In certain embodiments, the FA is selected having a molecular weight below 100 g/mol. Additionally or alternatively, the FA may have a molecular weight below 120 g/mol, below 150 g/mol, below 175 g/mol, or greater than these values.

In certain embodiments, the aqueous solution includes an amount of hydrofluoric acid (HF). HF exhibits distinct reactions from HCl, and is useful in certain applications to enhance the activity of the resulting aqueous solution. For example, HF is utilized in the cleanup of sandstone formations where HCl alone is not effective for removing certain types of formation damage. It is believed that the present aqueous solution will complex with HF similarly to the observed effects with HCl. Accordingly, solutions can be formulated with a total acid amount that is much higher than presently attainable formulations. In certain embodiments, the HF is present in an amount of at least 0.25% by weight. The HF may be present in an amount of up to 2%, up to 6%, up to 10%, up to 15%, or greater amounts. The HF may be present in addition to the amount of HCl, and/or as a substitution for an amount of the HCl.

An example aqueous solution includes a solution exhibiting an acid retardation factor of at least 3 at 20° C. Example and non-limiting solutions exhibiting a retardation factor of at least 3 include solutions listed in Table 1 following. An example aqueous solution includes a solution exhibiting an acid retardation factor of at least 3 at 20° C. Example and non-limiting solutions exhibiting a retardation factor of at least 10 include several solutions listed in Table 1 following.

Referencing Table 1, the observed retardation factors for a number of aqueous solutions with HCl and a FA are presented therein. Retardation factor indicates the time it took to retarded HCl of equal effective concentration to consume in the presence of certain limestone sample, compared to the case of straight HCl. It is noted that the HCl amounts were between 15% and 28% by weight. However, comparative data above 37% was not possible as such formulations have not been previously attained and a straight acid above 37% was not possible. Nevertheless, it is believed that the retardation effect of the FA observed in the formulations of Table 1 is relevant to formulations having greater than 37% HCl. The retardation factors in Table 1 were determined from reaction rates with a carbonate at 68° F. (20° C.). Where a very large retardation factor is shown (HIGH), that merely indicates that no observable (by sample weight) reaction had occurred in the time frame of the test. However, the retarded acid in the samples having a (HIGH) showed indicia of reaction, such as by bubble formulation on the surface of the carbonate sample utilized, and the acid therein was active and unspent.

TABLE 1
Observed retardation factors with certain Fixing Agents

| | | | | Effective | Retardation |
|---|---|---|---|---|---|
| FA | Mol. Wt. | Structure | FA:HCl | HCl % | factor |
| Urea | 60 | 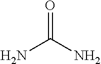 | 2 1 0.5 | 17 23 28 | 14 16 16 |
| 1,1-dimethyl urea | 88 | 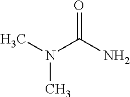 | 1.64 0.85 0.36 | 15 21 28 | 9 6 3 |
| 1,3-dimethyl urea | 88 | 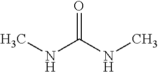 | 1.64 0.85 0.36 | 15 21 28 | 15 13 18 |
| 1,1-diethyl urea | 116 | 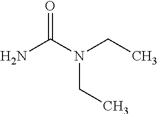 | 1 0.5 0.3 | 17 23 27 | 20 18 12 |
| 1,3-diethyl urea | 116 | 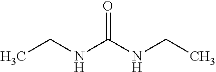 | 1.25 0.65 0.27 | 15 21 28 | HIGH HIGH HIGH |
| 1,3-diallyl urea | 140 | 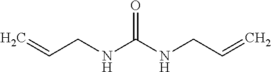 | 1.03 0.54 0.23 | 15 21 28 | HIGH HIGH HIGH |
| 1,3-dipropyl urea | 144 | 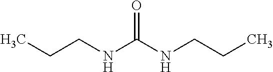 | 1 0.52 0.22 | 15 21 28 | HIGH HIGH HIGH |
| 1,3-dibutyl urea | 172 | 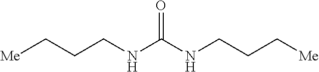 [SMILES: CCCCNC(=O)NCCCC] | 0.84 0.44 0.18 | 15 21 28 | HIGH HIGH 33 |
| 1,1,3,3-tetra methyl urea | 116 | 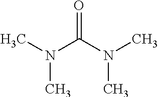 | 1.25 0.65 0.27 | 15 21 28 | 33 15 10 |
| 1,1,3,3-tetra ethyl urea | 172 | 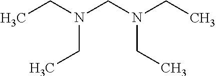 | 0.84 0.44 0.18 | 15 21 28 | 20 13 8 |
| 2-aminoethyl urea | 113 | 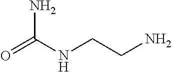 | 1 1 1 | 15 21 28 | HIGH HIGH HIGH |

As can be seen in Table 1, a variety of FA and HCl concentrations provide for significant retardation of the HCl activity over HCl without a FA present. It is believed that the retardation of HCl activity continues for concentrations of HCl exceeding 37%, although comparative data is not possible as discussed preceding. In certain embodiments, the retardation is sufficient that usage and handling of the aqueous solution can be performed without additional acid retarders present in the aqueous solution. This can achieve cost savings and environmental improvements relative to acid retarders that may not be as easy to handle and dispose of as urea and urea derivatives. The addition of enough of any material will dilute the acid to a lower concentration and thereby reduce the acid capacity. An acid retarder, as used herein, includes any material that reduces acid intensity through a mechanism other than mere dilution. Non-limiting examples include chelating ligand based retarders, acid internal phase emulsions, and/or surfactant based retarders.

Certain example solutions herein include aqueous solutions having an HCl weight fraction greater than 37%, and certain procedures herein include providing and/or utilizing solutions having an HCl weight fraction greater than 37%. Such solutions are not previously attainable. The following section describes certain non-limiting procedures to provide aqueous solutions having an HCl weight fraction greater than 37%. One of skill it the art having the benefit of the disclosures herein will be able to prepare a solution having an HCl weight fraction greater than 37% using procedure informed by this disclosure but differing from the procedures herein. It is also noted that certain embodiments of the present disclosure include HCl solutions at lower than 37% by weight. Such solutions can be provided by conventional means, with the addition of the FA after the HCl, and/or with the HCl and FA added in any amounts and order until the target solution composition is achieved.

An example aqueous solution includes HCl in a weight fraction exceeding 37%. The aqueous solution includes a fixing agent (FA) provided that allows the HCl fraction to exceed the 37% normally understood to be the limit of HCl solubility at atmospheric pressure. Above 37%, normally, the evolution of HCl gas from the solution prevents the HCl fraction from getting any higher. In certain embodiments, the HCl weight fraction of the aqueous solution may be as high as 45.7%. In certain embodiments, the FA is selected to be 1,3-dimethyl urea and/or ethylene urea, and the HCl weight fraction of the aqueous solution is present at up to 41.1%.

The aqueous solution includes HCl and the FA both in solution. However, the FA and HCl may be added in any order, at least partially. For example, the FA may be dissolved in water, and then the HCl added by any method, such as bubbling HCl gas therethrough. In another example, the HCl is added, at least partially, first and then the FA is added thereafter, with the remaining HCl added with and/or after the FA. In another example, the FA is provided fully or partially as an undissolved solid which dissolves into the aqueous solution as the HCl is added. In certain embodiments, the amount of water present in the aqueous solution is between 0.3 and 1.3 times the amount of the FA, inclusive, by mass.

In certain embodiments, the aqueous solution has a fluid density exceeding 1.2 g/mL. It is noted that conventional 36% HCl at atmospheric pressure has a fluid density of about 1.18 g/mL. In certain embodiments, the fluid density of the aqueous solution may be less than 1.2 g/mL. Fluid densities of various aqueous solutions are depicted in Table 2, although the fluid densities in Table 2 are non-limiting examples.

A first example set of solutions was prepared in a 250 mL conic flask containing 23 g NaCl powder, with 11 mL 98% H₂SO₄ added to the container but physically separated from the NaCl. The vessel was tightly sealed with a 0.25″ i.d. tubing connected to the bottom of a tube containing 3 mL H₂O. Then 3.0 g urea powder was added to the tube. One example solution added 1.0 g of metal-organic framework (MOF) material to the tube, while another example solution did not add the MOF material to the tube. The conic flask was agitated, resulting in controlled mixing of the NaCl and H₂SO₄, leading to instant generation of nearly 100%, dry HCl gas which was in turn bubbled at a moderate rate through the H₂O solution in the tube. This process led to the dissolution of urea beyond its normal solubility in water. Without being limited to a theory of operation, it is believed that the adduction between HCl and urea via hydrogen bonding allowed for dissolution of urea beyond the normal solubility limit. At the end of the process, 1.0 mL of the HCl containing solution was weighed to measure its density. In addition, the solution was titrated against 15% NaOH solution in the presence of a droplet phenolsulfonphthalein indicator, from which the effective concentration of HCl was determined.

A second example solution was prepared in a 250 mL conic flask containing 23 g NaCl powder, with 11 mL 98% H₂SO₄ added to the container but physically separated from the NaCl. The vessel was tightly sealed with a 0.25″ i.d. tubing connected to the bottom of a tube containing 3 ml H₂O. Then 4.5 g of 1,3-dimethyl urea was added to the tube. The conic flask was agitated, resulting in controlled mixing of the NaCl and H₂SO₄, leading to instant generation of nearly 100%, dry HCl gas which was in turn bubbled at a moderate rate through the H₂O solution in the tube. This process led to the dissolution of 1,3-dimethyl urea beyond its normal solubility in water. At the end of the process, 1.0 mL of the HCl containing solution was weighted to measure its density. In addition, the solution was titrated against 15% NaOH solution in the presence of a droplet phenolsulfonphthalein dye, from which the effective concentration of HCl was determined.

Referencing Table 2, a number of experimental solutions are depicted. Each of the solutions depicted were created in a manner consistent with or similar to that described for the first example set of solutions and the second example solution described preceding.

TABLE 2
Example aqueous solutions

| | | Add'l. | | Effective HCl | Density |
|---|---|---|---|---|---|
| FA | Beginning solution | solid FA | | (wt %) | (g/mL) |
| Urea | 3 mL H₂O | 2.4 | g | 41.51 | 1.24 |
| Urea | 3 mL H₂O and 3 g | N/A | | 43.05 | 1.22 |
| | urea | | | | |
| Urea | 3 mL H₂O | 3 | g | 44.82 | 1.29 |
| Urea | 3 mL H₂O and 3 g | N/A | | 43.91 | 1.27 |
| | urea | | | | |
| Urea | 3 mL H₂O and 1 g | 3 | g | 45.72 | 1.45 |
| | MOF | | | | |
| Urea | 3 mL H₂O | 3.6 | g | 43.72 | 1.29 |
| Urea | 3 mL H₂O and 3 g | 6 | g | 42.05 | 1.26 |
| | urea | | | | |
| 1,3-Dimethyl | 3 mL H₂O | 4.5 | g | 41.15 | 1.18 |
| urea | | | | | |
| Ethylene | 3 mL H₂O | 4.5 | g | 41.15 | 1.26 |
| urea | | | | | |

It can be seen from Table 2 that a number of solutions having a FA and HCl were developed that have greater than 37% HCl by weight. The solutions were created by providing an initial aqueous solution, and dissolving HCl gas into the solution. In certain formulations, urea was present in the initial solution and/or added and dissolved with the HCl dissolving process. The formulations in Table 2 have higher HCl concentrations than previously known aqueous HCl formulations at ambient conditions. The fifth solution was formulated with metal organic framework (MOF) particles in the solution. The MOF particles may be removed after the HCl dissolution, or they may be left in the solution.

Without limiting the disclosure to a particular theory of operation, it is believed that the FA complexes with the HCl molecules to keep them in solution at higher concentrations than previously known. In certain embodiments, the FA includes a primary amine in the molecule (e.g. as in urea), and in certain embodiments, the FA includes a secondary nitrogen in the molecule (e.g. as in 1,3-dimethyl urea). Without limiting the disclosure to a particular theory of operation, it is believed the MOF particles, or other high surface area particles, temporarily store enough of the HCl bubbling through the solution to provide time for the FA to complex with the HCl molecules and keep them in solution at higher concentrations than previously attainable.

Subjectively, the formulated solution exhibits a very low fume profile, and is not irritating to an operator in the presence of the solution vapor. This contrasts sharply with standard HCl solutions, which are irritating even at low concentrations, and which are significantly more irritating and/or hazardous at higher concentrations. Without being limited to a theory of operation, it is believed that the lower fume profile is due to the greatly reduced vapor pressure of the HCl when complexed with the FA.

The formulations and data in Table 2 illustrate certain principles of the present disclosure. However, a given embodiment of the present disclosure may have a formulation different than those presented in Table 2, and certain embodiments of the present disclosure may not include a formula presented in Table 2. An aqueous solution may include one or more fixing agents, including a mixture of fixing agents. Where more than one FA is present in the aqueous solution, the molar ratio between the FA:HCl may be evaluated from the total sum of the fixing agents present in the solution.

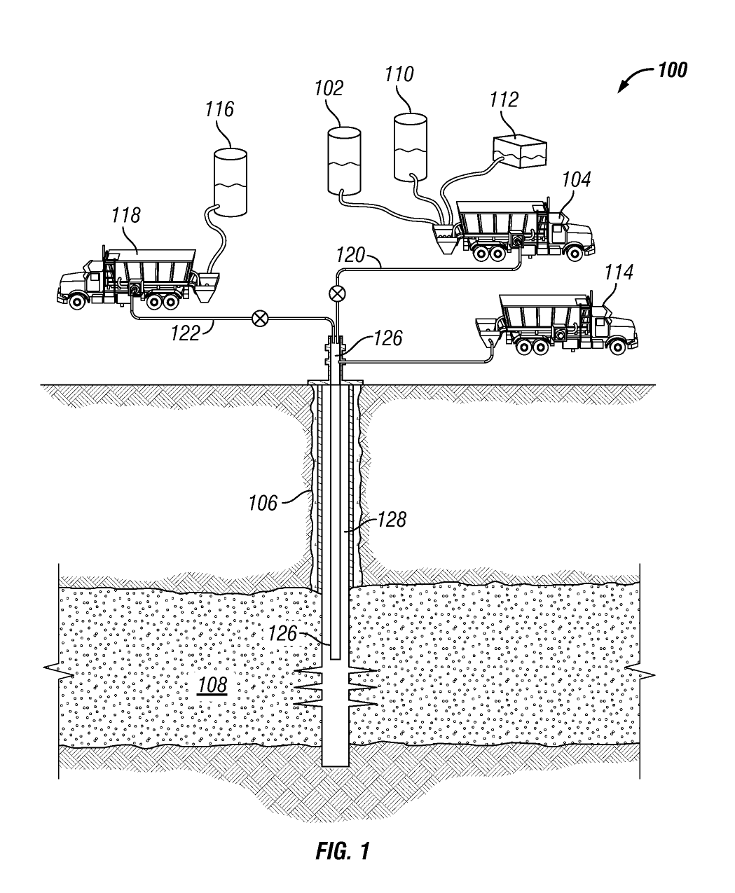

Referencing FIG. 1, a system 100 is depicted having example equipment to treat a wellbore 106 and/or a formation 108 fluidly coupled to the wellbore 106. The wellbore 106 is depicted as a vertical, cased and cemented wellbore 106, having perforations providing fluid communication between the formation 108 and the interior of the wellbore 106. However, none of the particular features of the wellbore 106 are limiting, and the example is provided only to provide an example context 100 for a procedure.

The system 100 includes a high pressure pump 104 having a source of an aqueous solution 102. In a first example, the aqueous solution 102 includes a FA and HCl, the HCl in an amount greater than 15% and up to 45.7%, and the FA present in a molar ratio between 0.15 and 2.5 inclusive. The aqueous solution 102 further includes water in an amount sufficient to dissolve the HCl and the FA, and the aqueous solution 102 includes substantially no polysaccharides. The high pressure pump 104 is fluidly coupled to the wellbore 106, through high pressure lines 120 in the example. The example system 100 includes a tubing 126 in the wellbore 106. The tubing 126 is optional and non-limiting. In certain examples, the tubing 106 may be omitted, a coiled tubing unit (not shown) may be present, and/or the high pressure pump 104 may be fluidly coupled to the casing or annulus 128.

Certain additives (not shown) may be added to the aqueous solution 102 to provide an oilfield treatment fluid. Additives may be added at a blender (not shown), at a mixing tub of the high pressure pump 104, and/or by any other method. In certain embodiments, a second fluid 110 may be a diluting fluid, and the aqueous solution 102 combined with some amount of the second fluid 110 may make up the oilfield treatment fluid. The diluting fluid may contain no HCl, and/or HCl at a lower concentration than the aqueous solution 102. The second fluid 110 may additionally or alternatively include any other materials to be added to the oilfield treatment fluid, including additional amounts of the FA, or of another FA (e.g. one having a higher molecular weight). In certain embodiments, an additional FA solution 112 is present and may be added to the aqueous solution 102 during a portion or all of the times when the aqueous solution 102 is being utilized. The additional FA solution 112 may include the same or a different FA from the aqueous solution 102, may include all of the FA for the oilfield treatment fluid, and/or may include FA at a distinct concentration from the aqueous solution.

The high pressure pump 104 can treat the wellbore 106 and/or the formation 108, for example by positioning fluid therein, by injecting the fluid into the wellbore 106, and/or by injecting the fluid into the formation 108. Example and non-limiting operations include any oilfield treatment without limitation. Potential fluid flows include flowing from the high pressure pump 104 into the tubing 126, into the formation 108, and/or into the annulus 128. The fluid may be recirculated out of the well before entering the formation 108, for example utilizing a back side pump 114. In the example, the annulus 128 is shown in fluid communication with the tubing 126, although in certain embodiments the annulus 128 and the tubing 126 may be isolated (e.g. with a packer). Another example fluid flow includes flowing the oilfield treatment fluid into the formation at a matrix rate (e.g. a rate at which the formation is able to accept fluid flow through normal porous flow), and/or at a rate which produces a pressure exceeding a hydraulic fracturing pressure. The fluid flow into the formation may be either flowed back out of the formation, and/or flushed away from the near wellbore area with a follow up fluid. Fluid flowed to the formation may be flowed to a pit or containment (not shown), back into a fluid tank, prepared for treatment, and/or managed in any other manner known in the art. Acid remaining in the returning fluid may be recovered or neutralized.

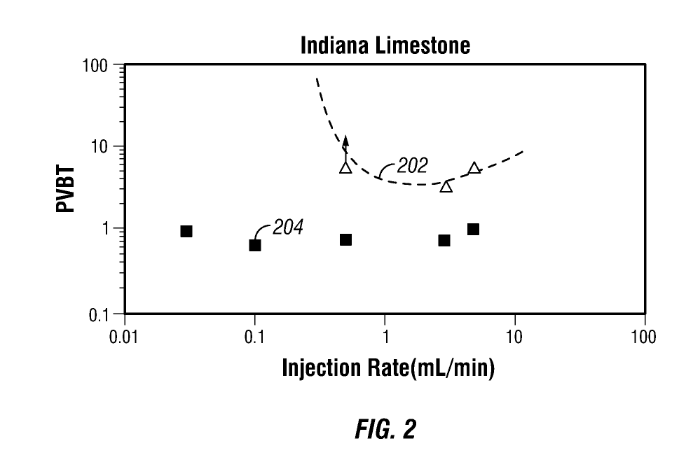

The formation 108 may be any type of formation. In certain embodiments, the formation 108 has a temperature exceeding 225° C., and/or has a temperature higher than 300° C., such as between 300° C. and 350° C. Conventional and conventionally retarded HCl solutions are known to exhibit very high reaction rates above 225° C., providing for rapid expenditure of the acid near the wellbore 106 resulting in a less effective treatment. Above 300° C., and even at lower temperatures in some circumstances, conventional and conventionally retarded HCl solutions do not typically provide for a commercially viable treatment. Referencing FIG. 2, data is depicted for an aqueous solution having HCl and a FA relative to an identical HCl solution having chelating ligand based retarder typical of what is used in presently known systems. The data of FIG. 2 indicates the pore-volume to breakthrough (PVBT) for two fluids at various pumping rates, which is the number of pore volumes of solution that are pumped into a core before breakthrough is observed on the opposite end of the limestone core. Some indication of retarded acid reaction rates can be shown where a lower pumping rate provides for the lowest PVBT. It can be seen that the aqueous solution having HCl and a FA (square points 204) displayed significantly retarded reaction rates relative to the typically retarded acid system (triangle points 202) at the temperature (300° C.) and HCl concentration of the test. The concentration of HCl in the data taken for FIG. 2 was 15% by weight, lower than an amount exceeding 37% by weight, however it is believed that acid retardation would be exhibited above 37% as well. Comparative data above 37% is not possible, as discussed preceding.

Another example fluid flow includes the aqueous solution 102 including HCl in an amount between 7.5% and 37%, with a FA being optional and in certain embodiments not present in the aqueous solution 102. The example fluid flow includes a second aqueous solution 116 including a FA (urea or a urea derivative) present in an amount between 10% by weight and 55% by weight. In certain embodiments, the FA may be present in amounts lower than 10%. The fluid flow includes, sequentially, a first high pressure pump 104 and a second high pressure pump 118 treating the formation 108. The second high pressure pump 118 in the example is fluidly coupled to the tubing 126 through a second high pressure line 122. The fluid delivery arrangement is optional and non-limiting. In certain embodiments, a single pump may deliver both the aqueous solution 102 and the second aqueous solution 116. In the example, either the first aqueous solution 102 or the second aqueous solution 116 may be delivered first, and one or more of the solutions 102, 116 may be delivered in multiple stages, including potentially some stages where the solutions 102, 116 are mixed.

The schematic flow descriptions which follow provide illustrative embodiments of performing procedures for treating formations and/or wellbores. Operations illustrated are understood to be examples only, and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

An example set of procedures includes an operation to prepare an aqueous solution having HCl in an amount greater than 15% and up to 45.7% inclusive. The aqueous solution includes a FA present in a molar ratio of FA:HCl between 0.15 and 2.5 inclusive, where the FA is urea and/or a urea derivative. The solution further includes water at least sufficient to dissolve the HCl and the FA, and substantially includes no polysaccharides. The procedure further includes an operation to provide an oilfield treatment fluid that includes the aqueous solution to a high pressure pump, and an operation to treat a wellbore and/or a formation fluidly coupled to the wellbore. Treatment of the wellbore includes, at least, positioning the oilfield treatment fluid into a tubing, a casing, and/or an annulus of one or more tubing or casing devices. The treatment of the wellbore further includes residing the oilfield treatment fluid into the tubing, casing, and/or annulus for a period of time.

Further example operations of the set of procedures are described following. A procedure includes diluting the HCl amount in the aqueous solution to an amount not greater than 28% by weight. An example procedure further includes providing the aqueous solution having HCl in an amount greater than 37%, transporting the aqueous solution to a location in treatment proximity to the wellbore, and where the operation to provide the treatment to the wellbore includes diluting the aqueous solution to a treatment concentration before the operation to provide the oilfield treatment fluid to the high pressure pump. An example procedure includes preparing the aqueous solution without a separate acid retarder (other than the FA), and preparing the aqueous solution to exhibit an acid retardation factor at 20° C. that is at least 3, at least 8, at least 10, at least 12, at least 14, and/or at least 20. An example procedure includes an operation to dilute the aqueous solution, adding an additional amount of the FA during the dilution operation, and providing the oilfield treatment fluid with FA:HCl in a molar ratio between 1 and 2, inclusive.

An example procedure further includes operating the high pressure pump by injecting the oilfield treatment fluid into the formation at matrix rates and/or injecting the oilfield treatment fluid into the formation at a pressure that is at least equal to the hydraulic fracturing pressure. An example procedure include operating the high pressure pump by contacting the wellbore and/or the formation with the oilfield treatment fluid. An example operation includes providing the oilfield treatment fluid with HF in an amount of at least 0.25%. The amount of HF may be in addition to, and/or substituting at least a portion of the amount of HCl.

Another example set of procedures includes an operation to prepare a first aqueous solution having HCl in an amount between 7.5% and 37% by weight, inclusive, and an operation to prepare a second aqueous solution having a FA (urea and/or a urea derivative) in an amount between 10% by weight and 55% by weight, inclusive. The procedure further includes treating a formation fluidly coupled to a wellbore with a first oilfield treatment that includes the first aqueous solution and a second oilfield treatment fluid that includes the second aqueous solution. The operation to treat the formation is performed sequentially, and with either the first oilfield treatment fluid or the second oilfield treatment fluid being first. Further example operations of the set of procedures are described following.

An example procedure includes the first aqueous solution having a FA present in a molar ratio of 0.15 to 2.5 inclusive. An example procedure includes the second aqueous solution having HCl in an amount exceeding 15% and up to 28%, inclusive, where the FA is present in an molar ratio FA:HCl between 0.15 and 2.5, inclusive. The example second aqueous solution further includes substantially no polysaccharides.

Without limitation, it is contemplated the procedure includes any one of a number of specific embodiments. An example includes treating with the first oilfield treatment fluid and then the second oilfield treatment fluid, or treating with the second oilfield treatment fluid then the first oilfield treatment fluid. An example includes the first oilfield treatment fluid including no FA, including FA in an amount distinct from the amount of FA in the second oilfield treatment fluid, and/or including FA in an amount that is the same or similar to the amount of FA in the second oilfield treatment fluid. An example includes the second oilfield treatment fluid including no HCl, including HCl in an amount distinct from the amount of HCl in the first oilfield treatment fluid, and/or including FA in an amount that is the same or similar to the amount of FA in the first oilfield treatment fluid. The first and second oilfield treatment fluids do not include both the HCl amount and the FA amount present in identical amounts with each other, although either one of the HCl amount or the FA amount may be present in identical amounts with each other. Additionally, it is contemplated that multiple stages of the first oilfield treatment fluid and/or the second oilfield treatment fluid may be performed, which stages may be equal or unequal in size or number, and/or which may include spacer fluids or not between any one or more of the stages.

As is evident from the figures and text presented above, a variety of embodiments according to the present disclosure are contemplated.

While the disclosure has provided specific and detailed descriptions to various embodiments, the same is to be considered as illustrative and not restrictive in character. Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

Moreover, in reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. It is the express intention of the applicant not to invoke 35 U.S.C. §112, paragraph 6 for any limitations of any of the claims herein, except for those in which the claim expressly uses the words ‘means for’ together with an associated function.

We claim:

1. An aqueous solution, comprising:
HCl in an amount between a first value exceeding 15% and a second value of 45.7% by weight, inclusive;
a fixing agent (FA) present in a molar ratio of FA:HCl between 0.15 and 2.5 inclusive, wherein the FA comprises at least one of urea and a urea derivative;
water present in an amount sufficient to dissolve the HCl and the FA; and
wherein the aqueous solution comprises substantially no polysaccharides.

2. The aqueous solution of claim 1, wherein the FA is further present in a molar ratio of FA:HCl having one of the range values selected from the range values consisting of: between 1.0 and 2.0 inclusive, between 0.5 and 2.0 inclusive, between 0.5 and 1.25 inclusive, between 0.3 and 1.25 inclusive, between 1.0 and 1.7 inclusive, and about 1.7.

3. The aqueous solution of claim 1, further comprising HF in an amount of at least 0.25% by weight.

4. The aqueous solution of claim 1, wherein the FA further comprises at least one molecular species, and wherein the aqueous solution further comprises a formulation selected from the formulations consisting of:
each of the at least one molecular species comprising a molecule having a molecular weight below 100 g/mol, and wherein the FA is further present in a molar ratio of FA:HCl between 0.3 and 1.65 inclusive;
each of the at least one molecular species comprising a molecule having a molecular weight below 120 g/mol, and wherein the FA is further present in a molar ratio of FA:HCl between 0.27 and 1.25 inclusive;
each of the at least one molecular species comprising a molecule having a molecular weight below 150 g/mol, and wherein the FA is further present in a molar ratio of FA:HCl between 0.22 and 1.05 inclusive; and
each of the at least one molecular species comprising a molecule having a molecular weight below 175 g/mol, and wherein the FA is further present in a molar ratio of FA:HCl between 0.18 and 1.0 inclusive.

5. The aqueous solution of claim 1, wherein the FA comprises urea, and wherein the FA is further present in a molar ratio of FA:HCl between 0.5 and 2.25 inclusive.

6. The aqueous solution of claim 1, wherein the aqueous solution does not include a separate acid retarder, and wherein the aqueous solution exhibits an acid retardation factor of at least 3 at 20° C. (68° F.).

7. The aqueous solution of claim 1, wherein the aqueous solution does not include a separate acid retarder, and wherein the aqueous solution exhibits an acid retardation factor of at least 10 at 20° C. (68° F.).

8. A method of treating a formation, comprising:
preparing an aqueous solution comprising HCl in an amount between a first value exceeding 15% and second value of 45.7% by weight, inclusive, a fixing agent (FA) present in a molar ratio of FA:HCl between 0.15 and 2.5 inclusive, wherein the FA comprises at least one of urea and a urea derivative, water present in an amount sufficient to dissolve the HCl and the FA, and wherein the aqueous solution comprises substantially no polysaccharides;
providing an oilfield treatment fluid including the aqueous solution to a high pressure pump; and
operating the high pressure pump to treat at least one of a wellbore and the formation fluidly coupled to the wellbore.

9. The method of claim 8, wherein the providing the oilfield treatment fluid further comprises diluting the aqueous solution to an HCl amount of not greater than 28% by weight inclusive.

10. The method of claim 9, wherein the aqueous solution further comprises an HCl amount between the first value exceeding 37% and the second value of 45.7%, the method further including transporting the aqueous solution to a location in treatment proximity to the wellbore, and wherein the providing the oilfield treatment fluid further comprises diluting the aqueous solution to a treatment concentration before the providing the oilfield treatment fluid to the high pressure pump.

11. The method of claim 10, wherein the preparing the aqueous solution further comprises preparing the aqueous solution without a separate acid retarder, and preparing the aqueous solution to exhibit an acid retardation factor at 20° C. (68° F.) selected from the acid retardation factors consisting of: at least 3, at least 8, at least 10, at least 12, at least 14, and at least 20.

12. The method of claim 10, wherein the diluting further comprises adding an additional amount of the FA, and wherein the FA is further present in the oilfield treatment fluid in a molar ratio of FA:HCl between 1 and 2 inclusive.

13. The method of claim 12, wherein operating the pump comprises at least one of:
injecting the oilfield treatment fluid into the formation at matrix rates;
injecting the oilfield treatment fluid into the formation at a pressure at least equal to the hydraulic fracturing pressure; and
contacting at least one of the wellbore and the formation with the oilfield treatment fluid.

14. The method of claim 8, wherein the oilfield treatment fluid further includes HF in an amount of at least 0.25%.

15. The method of claim 8, wherein the formation comprises a temperature of greater than 225° F. (107° C.).

16. The method of claim 15, wherein the oilfield treatment fluid does not include a separate acid retarder.

17. The method of claim 16, wherein the formation comprises a temperature between 300° F. (149° C.) and 350° F. (177° C.), and wherein the oilfield treatment fluid further includes the urea in a molar ratio of urea:HCl between 1.5 and 2 inclusive.

18. A method, comprising:
preparing a first aqueous solution comprising HCl in an amount between 7.5% and 37% by weight, inclusive;
preparing a second aqueous solution comprising at least one of urea and a urea derivative in an amount of at least 10% by weight and 55% by weight, inclusive;
treating a formation fluidly coupled to a wellbore with a first oilfield treatment fluid including the first aqueous solution and with a second oilfield treatment fluid including the second aqueous solution; and
wherein the treating is performed sequentially and with either the first oilfield treatment fluid or the second oilfield treatment fluid being first.

19. The method of claim 18, wherein the first aqueous solution further comprises a fixing agent (FA) present in a molar ratio of FA:HCl between 0.15 and 2.5 inclusive, wherein the FA comprises at least one of urea and a urea derivative.

20. The method of claim 18, wherein the second aqueous solution further comprises HCl in an amount between a first value exceeding 15% and a second value of 28% by weight, inclusive, wherein the at least one of urea and a urea derivative comprises a fixing agent (FA) which is further present in a molar ratio of FA:HCl between 0.15 and 2.5 inclusive, and wherein the second aqueous solution further comprises substantially no polysaccharides.
